(19) United States
(12) Patent Application Publication
(10) Pub. No.: US 2026/0129054 A1
(43) Pub. Date: May 7, 2026

(54) DETERMINING MICROSERVICE RESOURCE AVAILABILITIES BASED ON THREAT INTELLIGENCE AND HEALTH METRIC VALUES

(71) Applicant: HEWLETT PACKARD ENTERPRISE DEVELOPMENT LP, Spring, TX (US)

(72) Inventors: Phanidhar Koganti, Frisco, TX (US); Vidya R. Gudlavalleti, San Jose, CA (US)

(21) Appl. No.: 18/816,302

(22) Filed: Aug. 27, 2024

(51) Int. Cl. H04L 9/40

(52) U.S. Cl. CPC H04L 63/1416; H04L 63/1491

(57) ABSTRACT

A technique includes monitoring health metric values associated with a collection of monitored resources associated with a microservice. The technique includes determining based on the health metric values, whether each resource of the collection of monitored resources is healthy or unhealthy. The determination of whether each resource is healthy or unhealthy includes determining that a given resource of the collection of resources is healthy. The technique includes for each resource of the collection of resources, monitoring an associated security status of the resource; and determining availability statuses for the collection of resources. Determining the availability statuses includes classifying each resource that is unhealthy as being unavailable and classifying the given resource as being unavailable responsive to the security status associated with the given resource. The technique includes determining a resource availability of the microservice based on the availability statuses.

### BACKGROUND

A business enterprise may rely on any of a number of different computing environments to provide its services. In examples, the computing environments for a particular business enterprise may be confined to a private cloud (e.g., an on-premise datacenter), confined to a public cloud, or distributed across a hybrid cloud that includes both public and private clouds. A business enterprise may subscribe to an information technology (IT) operations management (ITOM) platform (e.g., a public cloud-based, software-as-a-service (Saas) platform) for such purposes as monitoring service availabilities; and detecting, predicting and remediating service issues.

### BRIEF DESCRIPTION OF THE DRAWINGS

FIG. 1 is a block diagram of a computer network that includes a threat intelligence-aware operations management service to monitor microservice resource availabilities according to an example implementation.

FIG. 2 is a block diagram of a threat intelligence-aware operations management system according to an example implementation.

FIG. 3 is an example snapshot of a dashboard of a threat intelligence-aware operations management system, illustrating use of the dashboard to monitor and manage microservice resource availabilities according to an example implementation.

FIG. 4 is a sequence diagram depicting communications among components of a threat intelligence-aware operations management system according to an example implementation.

FIG. 5 is a flow diagram depicting a technique to determine a security status of a resource based on threat intelligence according to an example implementation.

FIG. 6 is a flow diagram depicting a technique to determine microservice resource availability based on resource health metric values and resource security statuses according to an example implementation.

FIG. 7 is a block diagram of an information technology (IT) operations management system to determine resource availabilities based on resource health metric values and resource security statuses according to an example implementation.

FIG. 8 is an illustration of instructions that are stored on a non-transitory hardware processor-readable storage medium, which when executed by a hardware processor, cause the IT operations management system to determine microservice resource availability based on metric data and threat intelligence according to an example implementation.

### DETAILED DESCRIPTION

In one type of application architecture, an application may be monolithic and correspond to a single unit. In another type of application architecture, an application may be formed from multiple, autonomous parts called “microservices.” As compared to the monolithic architecture, the microservice architecture provides greater agility, elasticity and greater control for software quality assurance. Moreover, the microservice architecture may be better suited for a cloud deployment of an application.

A microservice may be provided by a container environment. In this context, a “container environment” refers to a collection of one or multiple instantiated containers (also referred to herein as “containers”). For a container environment that includes multiple containers, the containers may collaborate for a particular purpose (e.g., providing a microservice). A container environment may be orchestrated or non-orchestrated (or “self-managed”).

An orchestrated container environment has an orchestrator that manages the lifecycles and workloads of the environment's containers. In examples, an orchestrator may manage provisioning and resource allocation for the containers. In other examples, an orchestrator may manage container replication, when containers start and stop, container scaling, workload distribution among the containers, or other lifecycle phase or workload aspects of the container environment. In examples, an orchestrated container environment may have a KUBERNETES orchestrator or a DOCKER SWARM orchestrator. In an example, an orchestrated container environment may be a container cluster (e.g., a KUBERNETES cluster) that has a control plane and worker nodes.

Regardless of its particular architecture, a microservice has a number of supporting resources. In the context that is used herein, a “resource” refers to a component, such as a container or a group of containers (called a “container pod” or “pod”). Depending on its complexity (e.g., the degree of scaling, fault tolerance features, the number of entities communicating with the microservice, as well as other features), a given microservice may have hundreds or even thousands of resources. For purposes of managing its microservices, a business entity customer may subscribe to an information technology (IT) operations management (ITOM) platform (a platform provided by a public cloud provider “as-a-service”). The ITOM platform monitors metrics (e.g., kube metrics) of the microservice resources for purposes of assessing resource health and through a user graphical user interface (GUI), or dashboard, displaying health statuses of the resources. A healthy resource is considered to be “available” to support its microservice and an unhealthy resource is considered to be “unavailable,” or not capable of supporting its microservice. The ITOM may also monitor the percentage of unavailable resources (out of the total resources) for a microservice, which may be referred to as the overall availability (or “microservice resource availability”). The customer may set a lower boundary threshold (e.g., a threshold of 90 percent), so that the dashboard alerts the customer if the microservice resource availability decreases below the threshold.

A computer system may have various defenses against security attacks, or intrusions, such as defenses to prevent security intrusions, detect security intrusions, detect security vulnerabilities and mitigate the degree of harm inflicted by security intrusions. In this context, a “security intrusion” (or “security attack”) refers to one action or multiple coordinated actions by a malevolent actor, or adversary, for purposes of seeking access to or harming a resource, a container environment, a compute node, or other component or environment associated with an application.

Bad actors have a culture of continuous innovation, so despite best efforts to protect microservice resources against security intrusions, some microservice resources, at a given time, may be security compromised. In this context, a resource being “security compromised” refers to the resource being subject to a security attack, or intrusion, or having an exposure, or vulnerability (herein called a “security vulnerability”), to a security intrusion. A particular resource, at a given time, may have zero, one or multiple security intrusions and/or zero, one or multiple security vulnerabilities.

A microservice resource may be healthy but nevertheless be security compromised. In an example, although metric values affiliated with a container may indicate that the container has an expected operating behavior (i.e., a behavior consistent with good health), the corresponding container image may have a security vulnerability that has yet to be exploited. In another example, a container may have an expected operating behavior consistent with good health, but because the container has been attacked by an adversary that uses a defense evasion tactic to avoid detection, the container may nevertheless be security compromised.

In accordance with example implementations that are described herein, a threat intelligence-aware operations management service (also called the “operations management service” herein) takes into account both health-related metrics and threat intelligence for purposes of assessing resource availabilities and assessing microservice resource availabilities. The threat intelligence may be provided by one or multiple threat intelligence sources (e.g., threat intelligence as-a-Service providers). In this context, “threat intelligence” generally refers to information that identifies one or multiple resources and indicates, for each identified resource, indicates a security-related status for the resources, such as whether the resource is security compromised. As further described herein, the threat intelligence may further reveal, for a security compromised resource, a context, such as a tactic, technique and sub-technique associated with an indicated security vulnerability or security intrusion.

In accordance with example implementations, the operations management service, based on a configured policy, classifies a resource as being unavailable if the threat intelligence indicates that the resource is security compromised, regardless of whether health-related metrics of the resource indicate that the resource is healthy or unhealthy. Using resource availabilities determined in this way, the operations management service determines and monitors the corresponding microservice resource availabilities for an application. In accordance with example implementations, responsive to a resource becoming unavailable, the operations management service may initiate one or multiple remedial actions to address the unavailability, such as generating a dashboard alert, isolating the resource, restarting the resource, patching an image associated with the resource, or other responsive measure. Moreover, the operations management service, in accordance with example implementations, allows a customer to set microservice resource thresholds for respective microservices. In this way, a microservice resource availability falling below its threshold triggers the microservice management service to alert the customer (e.g., provide a dashboard alert), as well as possibly initiate one or multiple other remedial actions.

Among the potential benefits of the threat intelligence-aware operations management service that is described herein, security compromised resources of a microservice may be identified and dealt with in a timely manner, even if the resources exhibit expected healthy behaviors. Moreover, the operations management service equips a business entity's operations team with the tools and knowledge to promptly respond to security intrusions and vulnerabilities that affect the business entity's microservices.

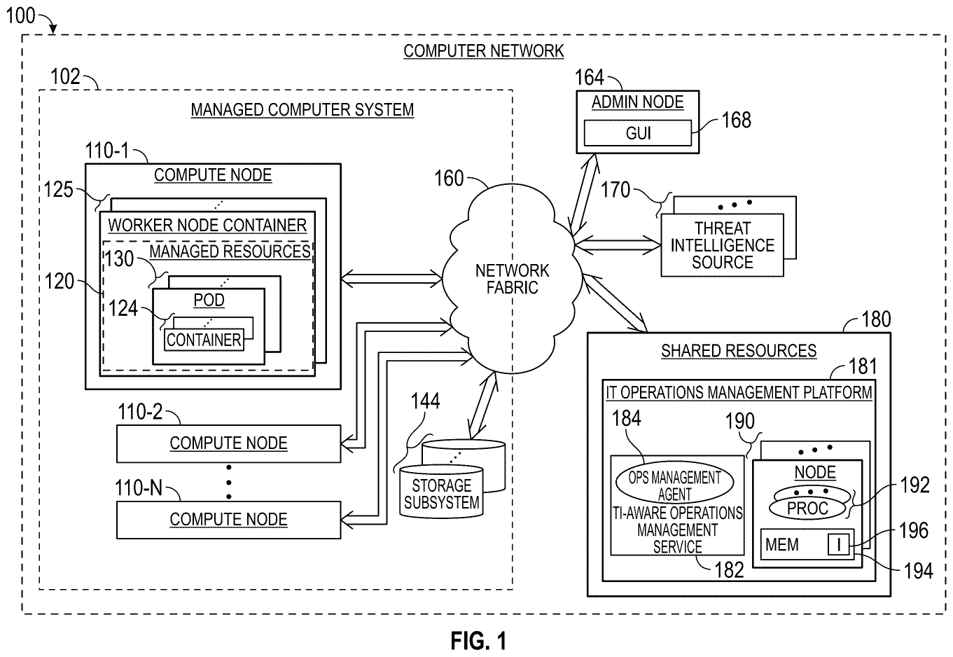

In a more specific example, FIG. 1 depicts a computer network 100 in accordance with some implementations. The computer network 100 includes a computer system 102 (called the “managed computer system 102” herein) that provides microservices that are associated with one or multiple applications. As further described herein, a threat intelligence-aware operations management service 182 (called the “management service 182” herein) monitors and manages resources 120 (called the “managed resources 120” herein) of the microservices. Depending on the particular implementation, a wide variety of microservice resources may be monitored and managed by the management service 182, ranging from the full set of resources (e.g., containers, container pods and virtual machines) that support the microservices to a subset of these resources. In an example, the managed resources 120 include a collection of containers 124. As depicted in FIG. 1, the containers 124 may be arranged in groups, or pods 130. In an example, an application corresponds to a container cluster (e.g., a KUBERNETES cluster), worker nodes of the container cluster provide respective microservices of the application, and each worker node includes one or multiple pods 130.

In accordance with example implementations, the operations management service 182 monitors operational behavior metrics (called “health metrics” or “health-related metrics” herein) of the monitored resources 120 for purposes of assessing and monitoring health statuses of the resources 120. In this manner, a “health status” is a classification for a resource 120, representing whether the resource 120 is healthy or unhealthy.

The operations management service 182 also receives, from one or multiple threat intelligence sources 170, one or multiple threat intelligence feeds. A given threat intelligence feed may correspond to a time sequence of threat intelligence reports, where each report identifies managed resources 120 that have security vulnerabilities and/or security intrusions. Based on the threat intelligence, the operations management service 182 determines security statuses for the managed resources 120. A “security status” is a classification for a managed resource 120, representing whether the resource 120 is security compromised or not. Because the health statuses and security statuses for the managed resources 120 change over time, the operations management service 182, in accordance with example implementations, continually assesses the health statuses, continually assesses the security statuses, and continually updates availability statuses for the managed resources 120.

In accordance with example implementations, the operations management service 182 considers a managed resource 120 to be “available” if the operations management service 182 determines that 1. the resource 120 is healthy, and 2. the resource is 120 is not security compromised. Otherwise, the operations management service 182 considers the resource 120 to be “unavailable.” In accordance with example implementations, the operations management service 182 continually determines and monitors a microservice resource availability for each microservice of the application. A “microservice resource availability,” in this context, refers to an assessment that is based on a ratio of the total number of available resources 120 of a microservice to the total number of managed resources 120 of the microservice. In examples, a microservice resource availability may be expressed as a fraction (e.g., expressed as the ratio) or expressed as a percentage (e.g., expressed as the ratio multiplied by one hundred).

The operations management service 182, in accordance with example implementations, allows the customer to define lower boundary thresholds (e.g., a percentage of 90%) for respective microservice resource availabilities. The operations management service 182 monitors the microservice resource availabilities against their respective lower boundary thresholds so that a microservice resource availability falling below its threshold triggers a remedial action by the operations management service 182. In an example of a remedial action, the operations management service 182 generates a dashboard alert to bring the customer's attention to a deficient microservice resource availability.

For the example implementation that is depicted in FIG. 1, the managed computer system 102 includes N compute nodes 110 (e.g., N computer platforms 110-1 to 110-N being represented in FIG. 1) that are connected to network fabric 160. In accordance with example implementations, the network fabric 160 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof. A portion of the network fabric 160 may be part of the managed computer system 102.

In the context that is used herein, a “compute node” refers to a platform that supports a microservice. In an example a compute node 110 is an actual, or physical, machine, such as a blade server, a rack server or a tower server. In another example a compute node 110 is a virtual machine (VM) that is hosted on a physical machine (e.g., a server). In another example, the compute nodes 110 for a particular application are a mixture of physical servers and VMs. In addition to the compute nodes 110 and network fabric 160, the managed computer system 102 may further include one or multiple storage subsystems 144 (e.g. one or multiple storage area networks or storage LANs) that are connected to the network fabric 160.

In an example, the microservices of an application are provided by one or multiple orchestrated container clusters (e.g., KUBERNETES clusters). Each microservice corresponds to a worker node of the cluster and runs in a respective container 125 that is allocated to and started on a respective compute node 110.

In an example, the managed computer system 102 corresponds to a public cloud. In another example, the managed computer system 102 is a private cloud that is managed by a business entity customer that subscribes to the operations management service 182 and includes on-premise servers that are located in one or multiple private datacenters or in leased space of one or multiple co-location data centers. In another example, the managed computer system 102 is a hybrid cloud that includes on-premise servers, which are managed by a public cloud provider.

The operations management service 182, in accordance with example implementations, is one of a suite of services (e.g., a collection of “as-a-Services”) that are provided by an information technology (IT) operations management platform 181. In an example, the IT operations management platform 181 is provided by resources 180 (called “shared resources 180” herein) that are shared by multiple tenants as part of a public cloud. The shared resources 180 are connected to the managed computer system 102 as well other managed computer systems (affiliated with the same customer or other customers) by the network fabric 160. In another example, the IT operations management platform 182 corresponds to a hybrid cloud. In another example, the IT operations management platform 182 corresponds to a private cloud. In another examples, the IT operations management platform 182 and the managed computer system 102 are part of the same private cloud or part of the same hybrid cloud.

In accordance with example implementations, an operations management agent 184 provides the threat intelligence-aware operations management service 182. The operations management agent 184 monitors metrics (called “health metrics”) that are associated with the managed resources 120 for purposes of assessing the health of each of the managed resources 120. This monitoring, in accordance with example implementations, is continuous in nature so that the operations management agent 184 becomes aware, in real time or near real time, when a particular managed resource 120 transitions from a healthy state to an unhealthy state. A human user 163 may, through a dashboard, or graphical user interface (GUI) 168, configure the operations management agent 184 with one or multiple policies that control how to classify the resources 120 as being healthy or unhealthy.

The operations management agent 184, in addition to tracking health statuses of the monitored resources 120, also tracks security statuses of the resources 120. In accordance with example implementations, the operations management agent 184 monitors threat intelligence that is provided by one or multiple threat intelligence sources 170 and determines security statuses for the managed resources 120 based on the threat intelligence. The operations management agent 184, in accordance with example implementations, updates the security statuses, in real time or near real time, based on the latest threat intelligence. As depicted in FIG. 1, the threat intelligence sources 170 are connected to the network fabric 160. In accordance with example implementations, the threat intelligence source 170 monitors the managed resources 120 and provides, to the operations management agent 184, threat intelligence for the managed resources 120.

The threat intelligence for a particular managed resource 120 may indicate no or multiple security issues. In an example, the threat intelligence for a particular managed resource 120 may reveal no security intrusion and no security vulnerability for the resource 120. In another example, the threat intelligence for a particular managed resource 120 may identify an actual security intrusion for the resource 120 as well as include context, or details, about the security intrusion. In another example, the threat intelligence for a particular managed resource 120 may identify a specific security vulnerability for the resource 120 as well as include context, or details, about the security vulnerability. In an example, for a security intrusion or a security vulnerability, the threat intelligence may identify a particular security intrusion goal, or tactic, and identify one or multiple documented security intrusion techniques to achieve the tactic. In another example, for a security intrusion or security vulnerability, the threat intelligence may identify a tactic and one or multiple techniques, as classified by the MITRE Adversarial Tactics, Techniques and Common Knowledge (or “MITRE ATT&CK”) security attack database (e.g., the MITRE ATT&CK matrix for enterprises covering techniques against container technologies). In another example, the threat intelligence may identify a confidence level of an indicated security intrusion or security vulnerability for a particular managed resource 120. In another example, the threat intelligence may contain a risk score for an indicated security vulnerability, which is a relative ranking (e.g., a ranking of 0 to 100) of the risk of the vulnerability.

The operations management agent 184, in accordance with example implementations, evaluates availabilities of the managed resources 120, in real time or near real time. In accordance with example implementations, the operations management agent 184 applies the following logic expression to determine the availability of a particular managed resource 120:

$$Available = Healthy \& ( Security Compromised ) !$$

In the expression above, “Available” is a Boolean variable that is TRUE for a managed resource 120 that is available and FALSE for a managed resource 120 that is unavailable. Moreover, in the expression above, “Healthy” is a Boolean variable that is TRUE for a managed resource 120 that is healthy and FALSE for a managed resource 120 that is unhealthy. Additionally, in the expression above, “Security Compromised” is a Boolean variable that is TRUE for a managed resource 120 that is security compromised and FALSE for a managed resource 120 that is not security compromised; and “!” represents the logical NOT operator.

The operations management agent 184 determines a resource availability (called a “microservice resource availability” herein) for a given microservice based on availability statuses for managed resources 120 associated with the microservice. The operations management agent 184 continually (e.g., periodically, pursuant to a non-periodic schedule or in response to events, such as changes in threat intelligence) updates the microservice resource availability, in real time or near real time. Moreover, in accordance with example implementations, the operations management agent 184 compares the microservice resource availability to a user-defined lower boundary threshold for purposes of determining whether or not to initiate an alert or initiate one or multiple other or additional remedial actions due the microservice resource availability declining below an acceptable level (as defined by the threshold).

The operations management agent 184, in accordance with example implementations, generates and continually updates data representing information about the managed resources 120 and sends the data to an interactive dashboard, or graphical user interface (GUI) 168. The GUI 168, in turn, graphically displays the information about the managed resources 120, for purposes of keeping a human user 163 informed about statuses (e.g., availabilities, health statuses and security statuses) of the managed resources 120 and statuses (microservice resource availabilities) of the microservices corresponding to the managed resources 120. The statuses may also include displayed alert indicators (e.g., certain text highlights or colors, flashing text, or other alert beacons) for the managed resources 120 and for the microservices. The alert indicators may, in examples, draw user attention to a microservice resource availability that is below a user-defined threshold, a managed resource 120 that is unhealthy, a managed resource 120 that is security compromised, or a managed resource 120 that is unavailable.

In addition to displaying information about the microservices and the managed resources 120, the GUI 168 may also, in accordance with example implementations, present graphical user controls (dropdown lists, buttons, text boxes, list boxes, radio buttons, checkboxes, text entry fields, slider and other user interfaces) that may be manipulated (e.g., manipulated through mouse movements, mouse button clicks, trackpad gestures, touch screen gestures, keyboard input) to provide user input. In an example, user input may set up the operations management service 182 to monitor and manage the managed resources 120, such as specifying, for example, identifiers (IDs) for the resources 120, associating the resources 120 with particular microservices, identifying pod internet protocol (IP) addresses, as well as provide other configuration and option information. In another example, user input selects the information that is displayed on the GUI 168, as well as the manner in which the information is displayed. In another example, user input selects options and policies for the operations management service 182. In an example, user input selects microservice resource availability lower boundary thresholds for respective microservices. In another example, user input configures a policy that controls when a particular managed resource 120 is and is not considered security compromised based on threat intelligence. In another example, user input configures a policy that configures when a particular managed resource 120 is and is not considered healthy.

In accordance with example implementations, the GUI 168 be associated with an administrative node 164 of the computer network 100. In an example, the administrative node 164 is a physical computer platform. In an example, the GUI 168 is browser-based, and the administrative node 164 is a client to a web server of the IT operations management platform 181. In an example, for purposes of interacting with the GUI 168, the client sends application programming interface (API) requests (e.g., representation state transfer (REST) API requests or gPRC request) to uniform resource locator (URL) associated with the web server, and the web server responds with API responses.

Among its other features, the IT operations management platform 181 includes one or multiple processing nodes 190. In an example, a processing node 190 may be a computer platform, such as a blade server, a rack server or other processor-based electronic device. The processing node 190 includes one or multiple hardware processors 192 and a memory 194. In an example, a hardware processor 192 may include one or multiple central processing unit (CPU) cores and/or one or multiple graphics processing unit (GPU) cores. In another example, a hardware processor 192 may include one or multiple semiconductor CPU packages (or “sockets”).

The memory 194 includes non-transitory storage media that may be formed from semiconductor storage devices, memristor-based storage devices, magnetic storage devices, phase change memory devices, a combination of devices of one or more of these storage technologies, and so forth. The memory 194 may represent a collection of memories of both volatile memory devices and non-volatile memory devices.

In an example one or multiple hardware processors 192 on one or multiple processing nodes 190 may execute machine-readable instructions, such as machine-readable instructions 196 that are stored in the memory 194, for purposes of providing one or multiple software components of the IT operations management platform 181, such as the operations management agent 184. In accordance with further implementations, a hardware processor 192 may be a hardware circuit that does not execute machine-executable instructions, such as an application specific integrated circuit (ASIC), field programmable gate array (FPGA), programmable logic device, a programmable logic device (PLD), or other hardware dedicated to providing one or multiple functions for the IT operations management platform 181.

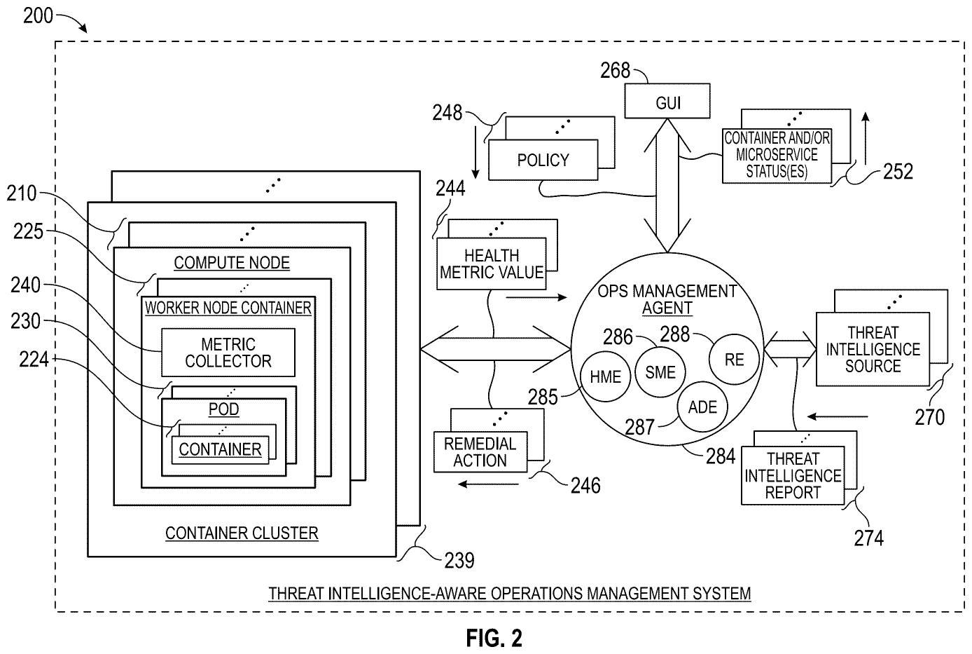

FIG. 2 depicts a threat intelligence-aware operations management system 200 in accordance with example implementations. The resource availability management system 200 includes an operations management agent 284 and a GUI 268, which, in an example, correspond to the operations management agent 184 and the GUI 168 of FIG. 1, respectively.

Referring to FIG. 2, for this example, the operations management agent 284 monitors availabilities of containers 224 that are associated with a collection of microservices of one or multiple applications. More specifically, FIG. 2 depicts container clusters 239. In an example, the container clusters 239 are associated with respective applications, and each application corresponds to a collection of microservices. In examples, a particular container cluster 239 may be a KUBERNETES or DOCKER SWARM container cluster. In an example, each microservice corresponds to a worker node of a cluster 239 and runs in a respective container 225 that is allocated to and started on a respective compute node 210. A compute node 210 may be a VM or a physical machine (e.g., a server). In an example, the container 225 may contain multiple pods 230, and each pod 230 contains one or multiple containers 224. In an example, the containers 224 corresponds to managed resources that are tracked by the operations management agent 284 for such purposes as determining and monitoring the health statuses and security statuses of the containers 224; determining and monitoring the availabilities of the containers 224; and determining and monitoring microservice resource availabilities based on the container availabilities.

In accordance with example implementations, the operations management agent 284 includes a health management engine 285 (e.g., a software component formed by the execution of hardware processor-readable instructions), which monitors health metric values 244 for the containers 224 for purposes of assessing container health metric values 244 for the containers 224 and determining, for each container 224, whether the container 224 is healthy or unhealthy. In accordance with example implementations, one or multiple metric collectors 240 of the container cluster 239 continually samples and provides the metrics health metric values 244 to the health management engine 285. In an example, the container cluster 239 is a KUBERNETES container cluster, and the compute nodes 210 of the container cluster 239 contain respective metric collectors 240 that provide the health metric values 244. In an example, the metric collector 240 is a kubelet.

The health management engine 285 may, based on the health metric values 244, determine the health statuses of the containers 224 in any of a number of different ways. In an example, one or multiple polices 248 may configure how the health management engine 285 determines health statuses for the containers 224. In an example, a user may, through the GUI 268, provide a policy 248 that sets forth criteria for determining the health statuses. In an example, a policy 248 identifies a collection of health metrics that are to be used for purposes of assessing the health status of a container 224. Continuing the example, the policy 248 may further specify metric value boundary thresholds for the respective health metrics for purposes of identifying expected ranges for the health metrics. In an example, a particular boundary threshold may define an upper ceiling for CPU utilization. A container CPU utilization below this threshold corresponds to an expected CPU utilization and CPU utilization above the thresholds corresponds to an unexpected CPU utilization. In an example, a policy 248 may specify one or multiple rules regarding how the specified health metrics are to be considered when evaluating container health. In an example, a rule may specify that a container 224 is unhealthy if any health metric value 244 (corresponding to the specified collection of health metrics for the container 224) is unexpected, and further specify that otherwise, the container 224 is considered healthy. In an example, a rule may specify that a container 224 is healthy unless a certain specified minimum number of health metric values 244 for the container 224 are unexpected.

Any of a number of different health metrics may be evaluated for purposes of monitoring container health. In an example, for a KUBERNETES cluster, a service of the KUBERNETES cluster may provide time series for corresponding performance metrics called “kube metrics.” In an example, kube metrics may represent CPU usage and memory usage of a container 224. In another example, kube metrics may represent network-related and storage-related statistics of a container 224. In another example, the kube metrics may represent a usage of a container's file system.

The operations management agent 284, in accordance with example implementations, includes a security management engine 286 (e.g., a software component formed by the execution of hardware processor-readable instructions). The security management engine 286, in accordance with example implementations, continually determines and monitors security statuses of the containers 224. The security management engine 286 monitors threat intelligence reports 274 that are provided by one or multiple threat intelligence sources 270. The particular threat intelligence sources 270 that are monitored may be controlled by a particular policy 248. Moreover, in accordance with example implementations, a policy 248 may control how the security management engine 286 interprets the threat intelligence reports 274 for purposes of determining, based on the information in the reports 274, when a particular container 224 is security compromised.

In an example, a particular policy 248 may specify that a container 224 is considered to be security compromised for any threat intelligence that represents that the container 224 has one or multiple security vulnerabilities and/or security intrusions. In another example, a particular policy 248 may specify that a container 224 is considered security compromised if threat intelligence indicates that either the container 224 has a security intrusion, or the combination of a security vulnerability for the container 224 and a security risk score above a certain threshold. In another example, a particular policy 248 may specify that a container 224 is considered security compromised if threat intelligence indicates that either the container 224 has a security intrusion, or the combination of the container 224 having one of a specified collection of security vulnerabilities. In another example, a policy 248 may specify that a container 224 is security compromised if the container 224 has a security intrusion corresponding to one of a collection of particular tactics. In another example, a policy 248 may specify that a container 224 is security compromised if the container 224 has a security intrusion corresponding to one of a collection of security intrusions corresponding to specific tactics and techniques.

In an example, the threat intelligence may correspond to a container MITRE ATT&CK matrix. The threat intelligence contains data representing tactics, or goals, of known security intrusions and documented techniques to achieve these goals. In examples, the container MITRE ATT&CK matrix may identify a wide variety of tactics, such as an initial access tactic, specifying ways in which an adversary may gain access to the container 224; an execution tactic to run malicious code; a persistence tactic related to a rogue agent maintaining its presence; a privilege escalation tactic; a defense evasion tactic to avoid detection; a credential access tactic; a discovery tactic used by an adversary to gain knowledge about the container 224 and its environment; and the lateral movement tactic used by the adversary to move through the environment. Each tactic may be achieved by a number of techniques, and moreover, a particular technique may be decomposed into sub-techniques. Accordingly, threat intelligence may document a particular security vulnerability or security intrusion as being associated with a particular tactic, one or multiple techniques and one or multiple sub-techniques.

The operations management agent 284, in accordance with example implementations, further includes an availability determination engine 287. The availability determination engine 287 (e.g., a software component formed by the execution of hardware processor-readable instructions) determines, for each container 224, an availability status based on the container's health status (e.g., healthy or unhealthy) and security status (e.g., security compromised or not security compromised). In accordance with example implementations, the availability determination engine 287 considers a container 224 to be available if the container is healthy and is not security compromised; and the availability determination engine 287 determines that a container 224 is unavailable if either the container 224 is unhealthy or is security compromised. The availability engine 287 further determines, in accordance with example implementations, a microservice resource availability for each microservice.

The availability determination engine 287, in accordance with example implementations, sends container and/or microservice statuses 252 to the GUI 268. In an example, a status 252 corresponds to data representing current availabilities of the respective containers 224. In another example, a status 252 corresponds to data representing current security statuses of the respective containers 224. In another example, a status 252 corresponds to data representing current health statuses of the respective containers 224. In another example, a status 252 corresponds to data representing current microservice resource availabilities. In another example, a status 252 is limited to indicating changes in resource and/or microservice status. The rate, or schedule, at which the availability determination engine 287 determines and updates container and microservice statuses, in accordance with example implementations, may be specified by one or multiple policies 248.

The management engine 284, in accordance with some implementations, further includes a remediation engine 288 (e.g., a software component formed by the execution of hardware processor-readable instructions). The remediation engine 288, in accordance with example implementations, initiates one or multiple remedial actions to a container 224 becoming unavailable. The particular remedial action(s), in accordance with example implementations, may depend on a policy 248. In an example of remedial actions, the remediation engine 288 may, responsive to a container 224 transitioning from an available status to an unavailable status, stop and then restart the container 224. In another example of remedial actions, the remediation engine 288 checks for patches or a more recent container image for a container 224 that is security compromised, and the remediation engine 288 builds and starts the container 224 with the patched or updated container image. In another example of a remedial action, the remediation engine 288 isolates a security compromised container 224 by stopping the container 224 and not restarting the container 224 until otherwise directed to do so via user input. In other examples of remedial actions, the remediation engine 288 may generate and send an alert to the GUI 268, send an alert message to a remote management server, quarantine a container cluster 238 from a network, and/or quiesce operations of a container cluster 239 associated with an entity that is external to the container cluster 239. In another example of a remedial, the remediation engine 288 may scan a container image. In an example, a policy 248 may select one or multiple remedial actions for initiation based on certain triggers.

In accordance with example implementations, the components of the operations management agent 284, such as the health management engine 285, the security management engine 286, the availability determination engine 287 and the remediation engine 288, may be respective microservices.

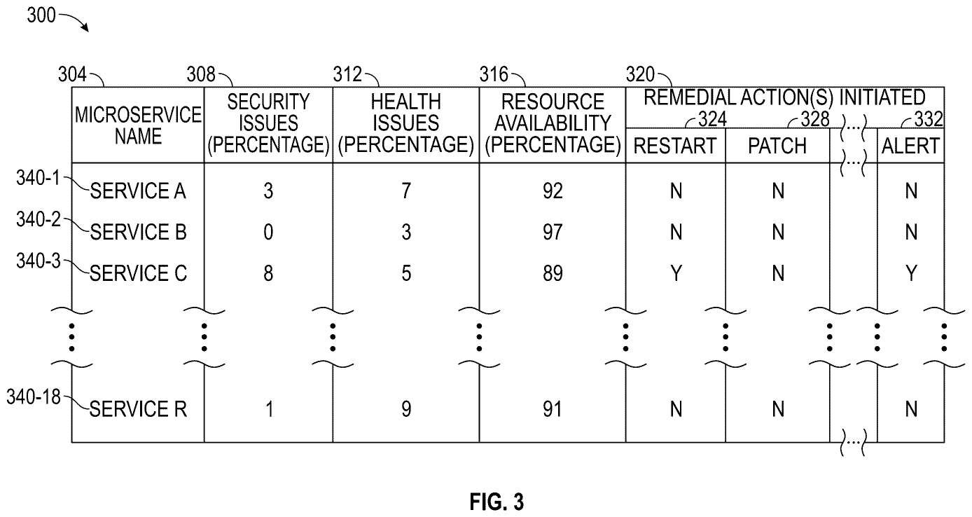

FIG. 3 depicts an example snapshot 300 of a GUI (e.g., the GUI 168 of FIG. 1 or the GUI 268 of FIG. 2) for purposes of illustrating the use of the GUI to manage and monitor microservice resource availability, according to example implementations. Referring to FIG. 3, for this example, the GUI displays security-related and health-related issues for various microservices.

More specifically, the GUI for this example displays rows 340-1 to 340-18 for respective microservices (e.g., a row 340-1 corresponding to a SERVICE A microservice, a row 340-2 corresponding to a SERVICE B microservice, and so forth). For each row 340, the GUI displays information about the corresponding microservice. More specifically, the display has a service name column 304, displaying a name of the microservice, a security issues column 308 containing percentages of security compromised resources for respective microservices, and a column 312 containing percentages of unhealthy resources of respective microservices.

In an example, 3% of the resources (e.g., containers) of the SERVICE A microservice (corresponding to row 340-1) are security compromised, and in another example, the SERVICE B microservice (corresponding to row 340-2) does not have any security compromised resources (e.g., containers). In another example, as depicted in column 312, 9% of the resources (e.g., containers) of the SERVICE R microservice (corresponding to row 340-18) are unhealthy. In another example, as also depicted in column 312, 5% of the resources of the SERVICE C microservice (corresponding to row 340-3) are unhealthy.

As also depicted in FIG. 3, for this example, the GUI displays a microservice resource availability percentage for each microservice. In particular, the SERVICE A microservice has a microservice resource availability of 92%, and the SERVICE C microservice has a microservice resource availability percentage of 89%. In accordance with example implementations, the GUI may present an alert indicator when a microservice resource availability decreases below a certain lower threshold boundary (e.g., a threshold boundary set by a user-specified policy option). In an example, the lower threshold boundary for microservice resource availability is 90%, and consequentially, the 89% microservice resource availability of the SERVICE C microservice is below this threshold.

The GUI may alert a user to the microservice resource availability decreasing below lower threshold boundary in any of a number of different ways. In examples, for a 90% lower threshold boundary, the GUI may alert the user to the low microservice resource availability for SERVICE C by displaying the “89” in a particular color (e.g., a red text color), flashing the “89,” or using another alert beacon that associates SERVICE C with a low microservice resource availability.

The GUI may also display, as depicted in FIG. 3, one or multiple columns related to remedial actions for each of the microservices. In an example, FIG. 3 depicts a collection 320 of columns, which contain remedial action-related information for the microservices. In an example, the collection 320 may include a column 332, which contains indications of whether alerts have been generated for respective microservices. The nature of the alert (e.g., a message, a GUI-displayed alert, and so forth) may depend on the particular user-specified policy. For the example of FIG. 3, the column 332 contains a “Y” representing a “YES” that an alert was generated for the SERVICE C microservice. In another example, the collection 320 may include a column 324 that contains values (e.g., “N” for “no” and “Y” for “yes”) for respective microservices, indicating whether or not unavailable resources (e.g., containers) have been stopped and restarted. In another example, the collection 320 may include a column 328 that indicates values representing whether or not unhealthy patches or image updates have been initiated for the resources (e.g., containers) that are unavailable. In a similar manner, the collection 320 may contain columns for other remedial actions, depending on the particular policy(ies) specified by the user.

In accordance with example implementations, graphical elements of the GUI may be associated with user controls that allow further investigation by the user. For example, a user may (e.g., via a trackpad, mouse or keyboard input) select the displayed “SERVICE C” text in the row 340-3 to cause the GUI to display specific information for the SERVICE C microservice, such as a scrollable listing of the microservice's containers, as well as other features and elements associated with the SERVICE C microservice.

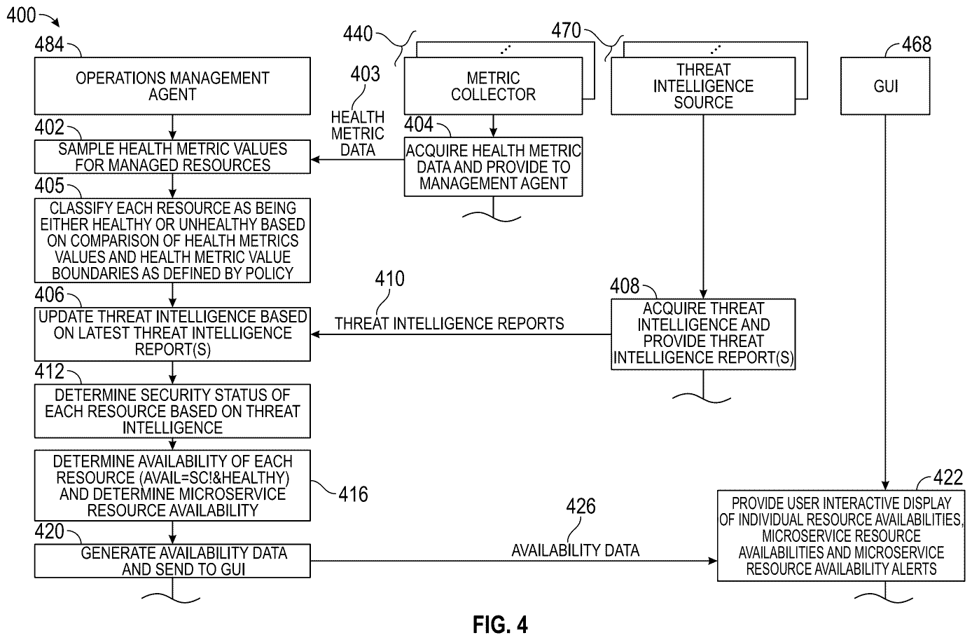

FIG. 4 depicts a sequence flow diagram 400 illustrating communications among components of a threat intelligence-aware operations management system according to example implementations. Referring to FIG. 4, the threat intelligence-aware operations management system, for this example, includes an operations management agent 484, metric collectors 440, one or multiple threat intelligence sources 470 and a GUI 468. In an example, the operations management agent 484, metric collectors 440, threat intelligent source(s) 470 and GUI 468 correspond to the operations management agent 284, metric collector 240, threat intelligence source(s) 270 and GUI 268 of FIG. 2.

The sequence flow diagram 400 includes operations that are performed by the operations management agent 484. Although FIG. 4 depicts the actions as being performed sequentially and in a particular example order, in accordance with further implementations, the operations management agent 484 may perform the actions in a different order, or perform some actions in parallel. For the example implementation depicted in FIG. 4, the operations management agent 484 samples (block 402) health metric values for a collection of managed resources that provide the microservices of an application. For this purpose, the operations management agent 484 may query, or request, health metric data 403 from the metric collectors 440. As depicted in block 404, the metric collectors 440 acquire the health metric data and provide the health metric data to the management agent 404. In accordance with some implementations, the metric collectors 440 may provide a continuous stream of health metric data 403 to the operations management agent 484, depending on the particular policy. As depicted in block 405, the operations management agent 484 classifies each resource as being healthy or unhealthy based on a comparison of the health metric values and health metric boundaries, as defined by policy.

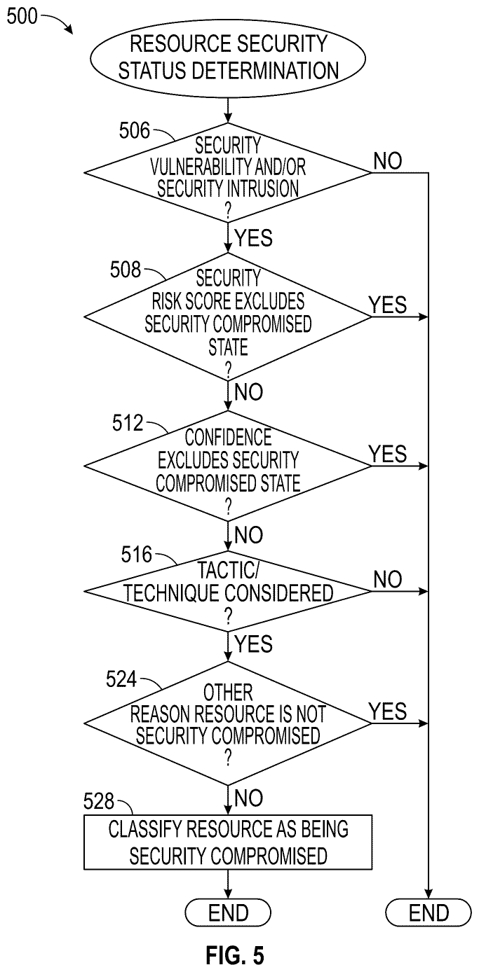

Pursuant to block 406, the operations management agent 484 updates threat intelligence based on the most recent threat intelligence reports 410. The threat intelligence reports correspond to one or multiple threat intelligence feeds from respective threat intelligence source(s) 470. The threat intelligence source 470 monitors resources (e.g., containers) that support the microservices of an application monitors acquires threat intelligence reports 410 from the threat intelligence source(s), which monitor the collection of monitored resources for security vulnerabilities and security intrusions and provide the threat intelligence reports, as depicted at 408. The operations management agent 484 determines (block 412) a security status of each resource, such as whether the resource is or is not security compromised, based on the threat intelligence reports 410. The operation management agent's security status classifications, in accordance with example implementations, may depend on a user-defined classification policy. An example technique 500 used to classify security statuses of the resources is described below in connection with FIG. 5.

Still referring to FIG. 4, pursuant to block 416, the operations management agent 484 next determines, based on the health statuses and security statuses, the availability of each resource. As depicted in block 416, in accordance with example implementations, the operations management agent 484 determines a particular resource's availability as a logical function of the resource's security status (e.g., security compromised or not security compromised) and health status (e.g., healthy or unhealthy). In an example, the operations management agent 484 determines that a particular resource is available if the resource is not security compromised and healthy. In another example, the operations management agent 484 determines that a particular resource is unavailable if the resource is either security compromised and or is unhealthy. Therefore, in an example, even if a resource is healthy, the resource is classified as being unavailable if the resource is security compromised.

As depicted at 420, the operations management agent 484 may generate availability data 426 and send the availability data 426 to the GUI 468. The GUI 468 may then display the resource availabilities and microservice resource availabilities, as depicted at 422.

FIG. 5 is a flow diagram 500 depicting a technique to determine a security status for a managed resource. The particular criteria considered in this determination, in accordance with example implementations, may be defined by one or multiple user-defined policies. In accordance with some implementations, the technique 500 may be performed by a threat intelligence-aware operations management engine, such as the operations management engine 184 (FIG. 1), the operations management engine 284 (FIG. 2) or the operations management engine 484 (FIG. 4).

In accordance with example implementations, the operations management engine, at the beginning of the technique 500 considers the resource to not be security compromised, and by applying the decisions of the technique 500, the operations management engine determines whether or not to change this classification to “security compromised.” The operations management engine may apply one of many different logical sequences for purposes of determining, from threat intelligence, whether a resource is or is not security compromised, depending on the particular policies and implementation. The technique 500 is merely an example logical sequence. Moreover, although FIG. 5 depicts decisions being made in a particular sequence, the sequence may be varied, different decisions may be made and some of the decisions may be made in parallel, in accordance with further implementations.

Pursuant to decision block 506, the operations management engine determines whether the threat intelligence represents that the resource has a security vulnerability or is subject to a security intrusion. If the threat intelligence represents that the resource neither has a security vulnerability nor is subject to a security intrusion, then, in accordance with example implementations, the security status classification ends. This results in the resource being classified as not being security compromised.

If, however, the threat intelligence represents a security vulnerability or a security intrusion for the resource, then operations management engine may consider one or multiple additional criteria for purposes of deciding whether or not the resource is security compromised. In an example, a security status classification policy may be relatively simple, in that if the threat intelligence reveals a security intrusion or security vulnerability, then the resource is considered to be security compromised, and otherwise, the resource is not considered to be security compromised.

In another example, a security status classification policy may be relatively more complex by considering one or multiple criteria of the threat intelligence when threat intelligence reveals a security intrusion or security vulnerability for a resource. More specifically, as depicted in decision block 508, the operations management engine determines whether a security risk score represented by the threat intelligence excludes a security compromised classification for the resource. In an example, the operations management engine considers the security risk score for security vulnerabilities, and if the threat intelligence represents a security vulnerability and a security risk score below a certain user-defined threshold, then the resource is not considered to be security compromised (i.e., the logic flow follows the “NO” prong of decision block 508). Continuing the example, if, however, the threat intelligence represents a security vulnerability and a security risk score above the user-defined threshold, then the resource may still be classified as being security compromised (i.e., the logic flow follows the “YES” prong of decision block 508).

As depicted in decision block 512, the operations management engine determines whether a confidence level of the threat intelligence excludes a security compromised classification for the resource. In an example, the threat intelligence may represent a confidence level of a security vulnerability detection or security intrusion detection. In an example, if the confidence level is below a certain user-defined threshold, then the resource is not considered to be security compromised (i.e., the logic follows the “NO” prong of decision block 512). Continuing the example, if, however, the threat intelligence represents a confidence level that meets or exceeds the user-defined threshold, then the resource may still be classified as being security compromised, and control proceeds to decision block 516.

As depicted in decision block 516, the operations management engine determines whether a tactic or tactic and technique combination represented by the threat intelligence excludes a security compromised classification for the resource. In an example, a security status classification policy may specify that all tactics of a particular container security matrix (e.g., the MITRE container matrix) are to be considered, and as such, threat intelligence that identifies any of these tactics results in a security compromised classification. In another example, a security status classification policy may specify certain tactics that correspond to a security compromised classification or exclude certain tactics so that any of these excluded tactics do not result in a security compromised classification. In a similar manner, a security status classification may identify specific combinations of tactics and techniques to include or exclude in making the decision of whether a resource is security compromised. In an example, if the threat intelligence represents a tacit or tactic and technique combination that is not, per policy, considered to correspond to a security compromised classification, then the resource is not considered to be security compromised (i.e., the logic follows the “NO” prong of decision block 516). Continuing the example, if, however, the threat intelligence represents a tacit or tactic and technique combination that is, per policy, considered to correspond to a security compromised classification, then, control proceeds to decision block 524.

If the technique 500 reaches decision block 524, then the threat intelligence represents the resource as having a security vulnerability and/or a security intrusion, and no reason has been identified for classifying the resource as “not security compromised.” If, pursuant to decision block 524, there is not another reason why the resource is not security compromised, then the resource is classified as being security compromised, pursuant to block 528.

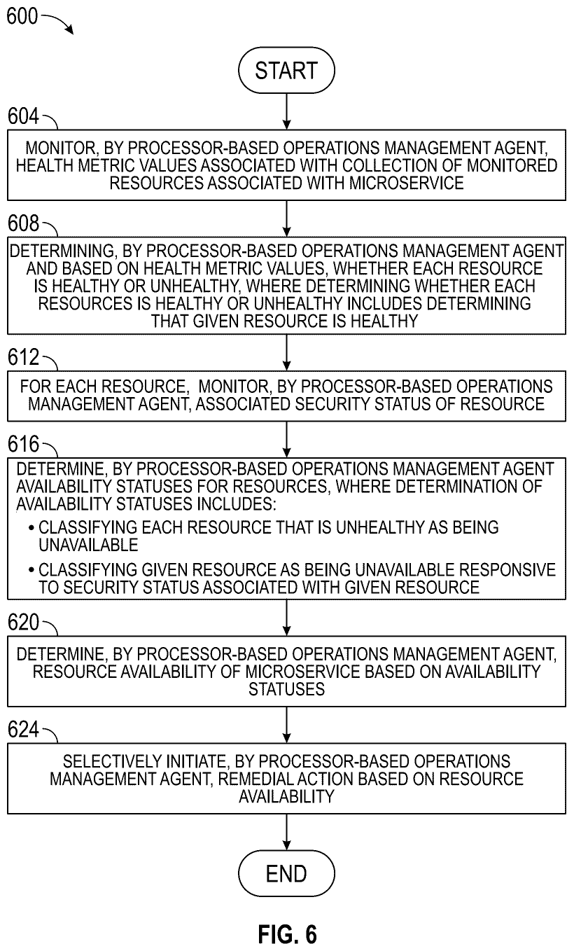

Referring to FIG. 6, in accordance with example implementations, a technique 600 includes monitoring (block 604), by a processor-based operations monitoring agent, health metric values that are associated with a collection of monitored resources associated with a microservice. In an example, the monitoring agent may correspond to an “as-a-service” provided by a cloud-based information technology (IT) operations management platform. In an example, the resources are containers. In an example, the containers correspond to a container cluster. In an example, the container cluster is a KUBERNETES cluster, and the health metric values are provided by kubelets that run on worker nodes of the cluster. In an example, the health metric values are kube metric values. In an example, the health metric values include values that represent CPU usages of the containers. In an example, the health metric values include values that represent memory usages of the containers. In an example, the health metric values include values that represent network-related statistics of the containers. In an example, the health metric values include values that represent storage-related statistics of the containers. In an example, the health metric values include values that represent file system usages.

The technique 600 includes determining (block 608), by the processor-based operations monitoring agent and based on the health metric values, whether each resource of the collection of monitored resources is healthy or unhealthy. The determination includes determining that a given resource of the collection of resources is healthy. In an example, determining that the given resource is healthy may include evaluating health metric values associated with the given resource for purposes of identifying any of the health metric values that are unexpected. In an example, depending on a user-specified policy, the given resource may be deemed healthy even if one of the health metric values is unexpected. In an example, the policy may specify that the given resource is considered healthy unless a certain minimum number of the health metric values associated with the given resource are unexpected. In another example, the policy may specify that the given resource is considered healthy unless at least one of the health metric values associated with the given resource is unexpected. In an example, an unexpected health metric value corresponds to the health metric value varying outside of an expected range having a boundary defined by a boundary threshold value.

Pursuant to block 612, for each resource of the collection of resources, the processor-based operations monitoring agent monitors an associated security status of the resource. In an example, monitoring the security status of a resource includes monitoring threat intelligence provided by one or multiple threat intelligence sources. In an example, the threat intelligence may represent whether or not a resource has a security vulnerability. In another example, the threat intelligence may represent whether or not a resource has a security vulnerability, and the threat intelligence may represent a security risk score for the security vulnerability. In another example, the threat intelligence may represent whether or not a resource has a security intrusion. In another example, the threat intelligence may represent whether or not a resource has a security intrusion, and the threat intelligence may represent a particular tactic associated with the security intrusion. In another example, the threat intelligence may further represent a technique associated with the tactic. In another example, the threat intelligence may represent a security intrusion or a security intrusion for a resource, and the threat intelligence may further represent a confidence level. In an example, a security status of a resource is a classification of whether or not the resource is security compromised.

Pursuant to block 616, the technique 600 includes determining availability statuses for the collection of resources. Determining the availability statuses includes classifying each resource of the collection of resources which is unhealthy as being unavailable; and classifying the given resource as being unavailable responsive to the security status associated with the given resource. In an example, the security status of the given resource classifies the given resource as being security compromised. In an example, the security status of the given resource classifies the given resource as being security compromised due to the resource having a security vulnerability. In an example, the security status of the given resource classifies the given resource as being security compromised due to the resource having a security intrusion. In an example, determining the availability statuses includes, for each resource, determining that the resource is available if the resource is healthy and is not security compromised. In an example, determining the availability statuses includes, for each resource, determining that the resource is unavailable if the resource is either unhealthy or is security compromised.

The technique 600 further includes, pursuant to block 620, determining, by the processor-based operations monitoring agent, a resource availability of the microservice based on the availability statuses. In an example, determining the resource availability of the microservice includes determining a ratio of the number of resources that are available to the total number of resources.

The processor-based operations monitoring agent, pursuant to block 624, selectively initiates a remedial action based on the resource availability. In an example, the remedial action is a display of an alert on a monitoring dashboard. In an example, the alert corresponds to a particular text color (e.g., a red text color) for a displayed resource availability for the microservice. In another example, the alert corresponds to flashing display of a resource availability for the microservice.

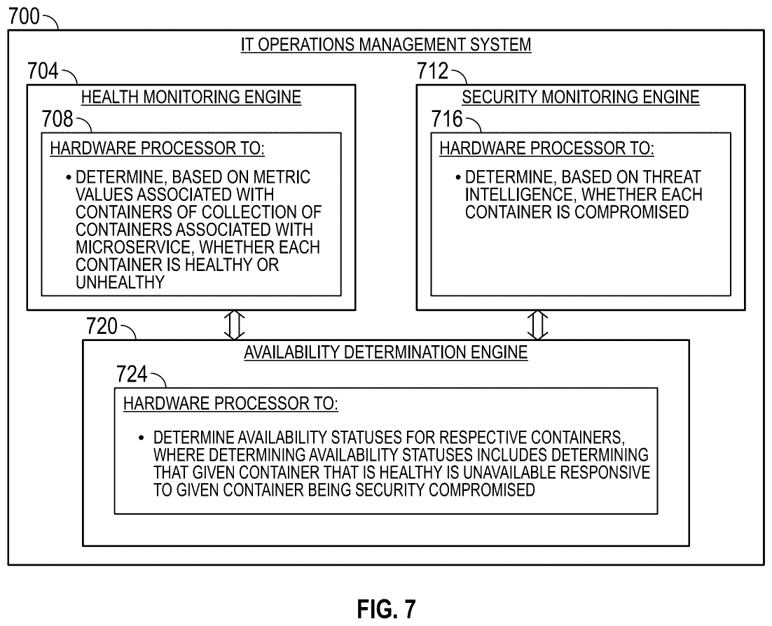

Referring to FIG. 7, in accordance with example implementations, an IT operations management system 700 includes a health monitoring engine 704, a security monitoring engine 712 and an availability determination engine 720. In an example, the IT operations management system 700 corresponds to an “as-a-service,” and the components of the system 700, such as the health monitoring engine 704, the security monitoring engine 712 and the availability determination engine 720, correspond a collection of cloud-based microservices. In an example, IT operations management system 700 monitors and manages microservices provided by a managed computer system. In an example, the managed computer system may be a private cloud, a public cloud or a hybrid cloud. The health monitoring engine 704, the security monitoring engine 712 and the availability determination engine 720 include hardware processors 708, 716 and 724, respectively. In an example, a hardware processor includes one or multiple CPU cores. In another example, a hardware processor includes one or multiple GPU cores.

The hardware processor 708 of the health monitoring engine 704 determines, based on metric values associated with containers of a collection of containers associated with a microservice, whether each container of the collection is healthy or unhealthy. In an example, the containers correspond to a container cluster. In an example, the container cluster is a KUBERNETES cluster, and the health metric values are provided by kubelets that run on worker nodes of the cluster. In an example, the health metric values are kube metric values. In an example, the health metric values include values that represent CPU usages of the containers. In an example, the health metric values include values that represent memory usages of the containers. In an example, the health metric values include values that represent network-related statistics of the containers. In an example, the health metric values include values that represent storage-related statistics of the containers. In an example, the health metric values include values that represent file system usages. In an example, determining whether a particular container is healthy includes comparing health metric values associated with the container to respective threshold values to identify any unexpected values, and assessing the container's health based on the number of unexpected values and a policy-defined rule.

The hardware processor 716 of the security monitoring engine 712 determines, based on threat intelligence, whether each container is compromised. In an example, the threat intelligence is provided by a single threat intelligence source. In another example, the threat intelligence is provided by multiple threat intelligence sources. In an example, the threat intelligence may represent whether or not a container has a security vulnerability. In another example, the threat intelligence may represent whether or not a container has a security vulnerability, and the threat intelligence may represent a security risk score for the security vulnerability. In another example, the threat intelligence may represent whether or not a container has a security intrusion. In another example, the threat intelligence may represent whether or not a container has a security intrusion, and the threat intelligence may represent a particular tactic associated with the security intrusion. In another example, the threat intelligence may further represent a technique associated with the tactic. In another example, the threat intelligence may represent a security intrusion or a security intrusion for a container, and the threat intelligence may further represent a confidence level. In an example, a security status of a container is a classification of whether or not the container is security compromised.

The hardware processor 724 of the availability determination engine 720 determine availability statuses for respective containers. Determining the availability statuses includes determining that a given container that is healthy is unavailable responsive to the given container being security compromised. In an example, determining the availability statuses further includes classifying another container, which is healthy and is not security compromised, as being available. In an example, determining the availability statuses further includes classifying another container, which is unhealthy and not security compromised, as being unavailable. In an example, determining the availability statuses further includes classifying another container, which is unhealthy and security compromised, as being unavailable.

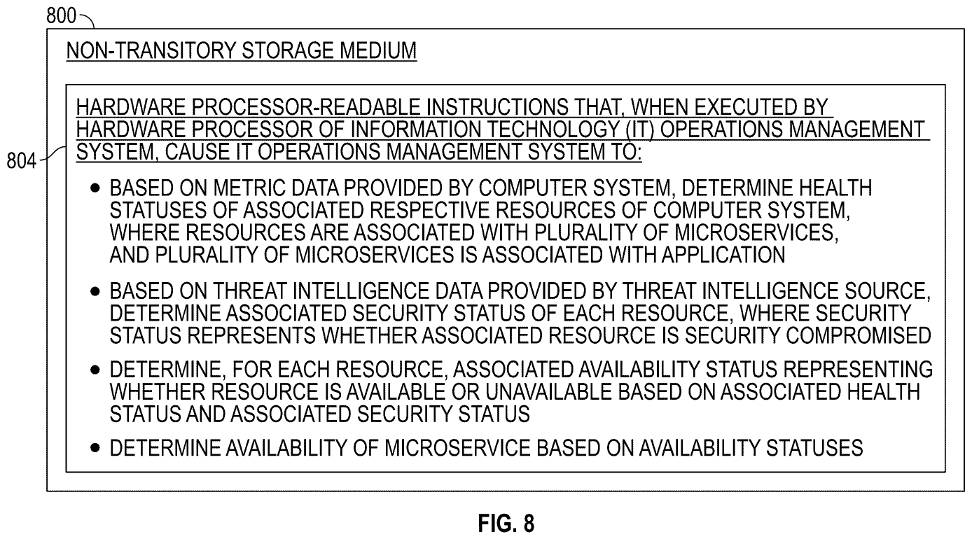

Referring to FIG. 8, in accordance with example implementations, a non-transitory system-readable storage medium 800 stores hardware processor-readable instructions 804. The instructions 804, when executed by a hardware processor of an information technology (IT) operations management system, cause the IT operations management system to, based on metric data provided by a computer system, determine health statuses of associated respective resources of a computer system. The resources are associated with a plurality of microservices, and the microservices are associated with an application. In an example, the execution of the instructions 804 corresponds to an “as-a-service” that is provided by the IT operations management system. In an example, the instructions 804 correspond to a collection of cloud-based microservices. In examples, the IT operations management system is associated with a private cloud, a public cloud or a hybrid cloud. In an example, the hardware processor includes one or multiple CPU cores. In another example, the hardware processor includes one or multiple GPU cores. In an example, the resources are containers.

The instructions 804, when executed by the hardware processor, further cause the IT operations management system to, based on threat intelligence data provided by a threat intelligence source, determine an associated security status of each resource. The security status represents whether the associated resource is security compromised. In an example, the instructions 804 cause the hardware processor to classify a resource as being security compromised responsive to the threat intelligence representing that the resource has a security vulnerability. In another example, the instructions 804 cause the hardware processor to classify the resource as being security compromised based on the threat intelligence representing that the resource has a security vulnerability and the threat intelligence representing a security risk score above a predefined score threshold. In an example, the instructions 804 cause the hardware processor to classify the resource as being security compromised responsive to the threat intelligence representing that the resource has a security intrusion. In an example, the instructions 804 cause the hardware processor to classify the resource as being security compromised responsive to the threat intelligence representing that the resource has a security intrusion and the threat intelligence further representing a particular tactic associated with the security intrusion.

The instructions 804, when executed by the hardware processor, further cause the IT operations management system to determine, for each resource of the collection, an associated availability status representing whether the resource is available or unavailable based on the associated health status and the associated security status. In an example, the instructions 804, when executed by the hardware processor, cause the hardware processor to classify a resource as being available responsive to the associated health status corresponding to the resource being healthy and the associated security status corresponding to the resource not being security compromised. In an example, the instructions 804, when executed by the hardware processor, cause the hardware processor to classify a resource as being unavailable responsive to the associated health status corresponding to the resource being unhealthy. In an example, the instructions 804, when executed by the hardware processor, cause the hardware processor to classify a resource as being unavailable responsive to the associated health status corresponding to the resource being healthy and the associated security status corresponding to the resource being security compromised.

The instructions 804, when executed by the hardware processor, further cause the IT operations management system to determine a resource availability of each microservice based on the availability statuses. In an example, the instructions, when executed by the hardware processor, further cause the hardware processor to determine the resource availability of a particular microservice based on a ratio of resources of the microservice that are available to a total number of resources of the microservice. In an example, the instructions, when executed by the hardware processor, further cause the IT operations management system to initiate a remedial action responsive to a resource being classified as being unavailability. In an example, a container is classified as being unavailable, and a remedial action involves the stopping and restarting of the container. In another example, a container is classified as being unavailable, and a remedial action involves patching an image associated with the container. In another example, a container is classified as being unavailable, and a remedial action involves replacing an image associated with the container. In another example, a container is classified as being unavailable, and a remedial action involves sending an alert corresponding to the container to a monitoring dashboard.

In accordance with example implementations, the collection of resources includes a plurality of containers. Determining the resource availability comprises determining a ratio of a number of containers of the plurality of containers which are available to the number of the containers of the plurality of containers. Among the potential benefits, security compromised resources of a microservice may be identified and dealt with in a timely manner, even if the resources exhibit healthy behaviors.

In accordance with example implementations, the monitoring includes receiving a threat intelligence; and determining, based on the threat intelligence, that the given resource is security compromised. Classifying the given resource as being unavailable includes determining that the given resource is unavailable responsive to the determination that the given resource is security compromised. Among the potential benefits, security compromised resources of a microservice may be identified and dealt with in a timely manner, even if the resources exhibit healthy behaviors.

In accordance with example implementations, determining that the given resource is security compromised includes determining that the threat intelligence represents that the given resource has an associated security intrusion. Among the potential benefits, security compromised resources of a microservice may be identified and dealt with in a timely manner, even if the resources exhibit healthy behaviors.

In accordance with example implementations, determining that the given resource is security compromised includes determining that the threat intelligence represents that the given resource has an associated security vulnerability. Among the potential benefits, security compromised resources of a microservice may be identified and dealt with in a timely manner, even if the resources exhibit healthy behaviors.

In accordance with example implementations, determining that the given resource is security compromised includes determining that the threat intelligence represents that the given resource has an associated security vulnerability and determining that the threat intelligence represents a security risk score greater than a predefined threshold. Among the potential benefits, security compromised resources of a microservice may be identified and dealt with in a timely manner, even if the resources exhibit healthy behaviors.

In accordance with example implementations, selectively initiating the remedial action includes comparing the resource availability of the microservice to a predefined resource availability threshold; and responsive to a result of the comparison, initiating the remedial action. Among the potential benefits, security compromised resources of a microservice may be identified and dealt with in a timely manner, even if the resources exhibit healthy behaviors.

In accordance with example implementations, the given resource is a container, and selectively initiating the remedial action includes at least one of generating data representing a monitoring dashboard alert; stopping the container; or restarting the container. Among the potential benefits, security compromised resources of a microservice may be identified and dealt with in a timely manner, even if the resources exhibit healthy behaviors.

In accordance with example implementations, the given resource is a container, and selectively initiating the remedial action includes at least one of patching an image associated with the container; or replacing the image. Among the potential benefits, security compromised resources of a microservice may be identified and dealt with in a timely manner, even if the resources exhibit healthy behaviors.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

1. A method comprising:
monitoring, by a processor-based operations monitoring agent, health metric values associated with a collection of monitored resources associated with a microservice, wherein the collection of resources comprises a plurality of containers that collectively provide the microservice;
determining, by the processor-based operations monitoring agent and based on the health metric values, whether each container of the plurality of containers is healthy or unhealthy, wherein the determining whether each container is healthy or unhealthy comprises determining that a given container of the plurality of containers is healthy;
for each container of the plurality of containers, monitoring, by the processor-based operations monitoring agent, an associated security status of the container;
determining availability statuses for the plurality of containers, wherein the determining the availability statuses comprises:
classifying each container of the plurality of containers which is unhealthy as being unavailable; and
classifying the given container as being unavailable responsive to the security status associated with the given container;
determining, by the processor-based operations monitoring agent, a resource availability of the microservice based on the availability statuses; and
selectively initiating, by the processor-based operations monitoring agent, a remedial action based on the resource availability.

2. The method of claim 1, wherein:
determining the resource availability comprises determining a ratio of a number of containers of the plurality of containers which are available to the number of the containers of the plurality of containers.

3. The method of claim 1, wherein:
the monitoring comprises:
receiving a threat intelligence; and
determining, based on the threat intelligence, that the given resource is security compromised; and
classifying the given resource as being unavailable comprises determining that the given resource is unavailable responsive to the determination that the given resource is security compromised.

4. The method of claim 3, wherein determining that the given resource is security compromised comprises determining that the threat intelligence represents that the given resource has an associated security intrusion.

5. The method of claim 3, wherein determining that the given resource is security compromised comprises determining that the threat intelligence represents that the given resource has an associated security vulnerability.

6. The method of claim 3, wherein determining that the given resource is security compromised comprises determining that the threat intelligence represents that the given resource has an associated security vulnerability and determining that the threat intelligence represents a security risk score greater than a predefined threshold.

7. The method of claim 1, wherein selectively initiating the remedial action comprises:
comparing the resource availability of the microservice to a predefined resource availability threshold; and
responsive to a result of the comparison, initiating the remedial action.

8. The method of claim 1, wherein the given resource comprises a container, and selectively initiating the remedial action comprises at least one of:
generating data representing a monitoring dashboard alert;
stopping the container; or
restarting the container.

9. The method of claim 1, wherein the given resource comprises a container, and selectively initiating the remedial action comprises at least one of:
patching an image associated with the container; or
replacing the image.

10. The method of claim 1, wherein:
the health metric values comprise a subset of health metric values associated with the given resource; and
determining that the given resource is healthy comprises:
determining whether the health metric values of the subset are expected; and
applying a rule to a result of determining whether the health metric values of the subset are expected.

11. The method of claim 10, wherein applying the rule comprises one of:
determining whether any of the health metric values of the subset is unexpected and marking the given resource as being healthy based on none of the health metric values of the subset being unexpected; or
determining a number of the health metric values of the subset as being unexpected and marking the given resource as being healthy based on the number being less than a predefined number threshold.

12. An information technology (IT) operations management system comprising:
a health monitoring engine comprising a hardware processor to determine, based on metric values associated with containers of a collection of containers, whether each container of the collection is healthy or unhealthy, wherein the collection of containers provides a microservice;
a security monitoring engine comprising a hardware processor to determine, based on threat intelligence, whether each container of the collection is compromised;
an availability determination engine comprising a hardware processor to:
determine availability statuses for respective containers of the collection of containers, wherein determining the availability statuses comprises determining that a given container of the collection of containers is unavailable responsive to the given container being security compromised, and wherein the given container is healthy; and
determine an availability of the microservice based on the availability statuses.

13. The IT operations management system of claim 12, wherein:
the availability determination engine determines the availability of the microservice based on a ratio of a first number of the containers of the collection indicated as being available by the associated availability statuses to the total number of containers of the collection.

14. The IT operations management system of claim 13, further comprising:
a remediation engine comprises a hardware processor to initiate a remedial action responsive to a comparison of the availability of the microservice to a predetermined availability threshold.

15. The IT operations management system of claim 14, wherein the hardware processor of the remediation engine to further, responsive to the comparison, generate data to display an alert on a monitoring dashboard associated with the microservice.

16. The IT operations management system of claim 14, wherein:
the hardware processor of the security monitoring engine to further determine that a second container of the collection of containers is security compromised based on the threat intelligence representing that the second container is either associated with a security intrusion or vulnerable to a security intrusion.

17. A non-transitory system-readable storage medium that stores hardware processor-readable instructions that, when executed by a hardware processor of an information technology (IT) operations management system, cause the IT operations management system to:
based on metric data provided by a computer system, determine health statuses of associated respective containers of a computer system, wherein the containers provide a plurality of microservices, and the plurality of microservices is associated with an application;
based on threat intelligence data provided by a threat intelligence source, determine an associated security status of each container of the containers, wherein the security status represents whether the associated container is security compromised;
determine, for each container of the collection, an associated availability status representing whether the container is available or unavailable based on the associated health status and the associated security status; and
determine a resource availability of each microservice based on the availability statuses.

18. The storage medium of claim 17, wherein the instructions, when executed by the hardware processor, further cause the IT operations management system to:
compare, for each resource availability, the resource availabilities to a resource availability threshold to provide a comparison result associated with the resource availability; and
initiate a remedial action responsive to a given comparison result of the comparison results.

19. The storage medium of claim 17, wherein the instructions, when executed by the hardware processor, further cause the IT operations management system to generate data to display the resource availabilities on a dashboard.

20. The storage medium of claim 17, wherein the instructions, when executed by the hardware processor, further cause the IT operations management system to receive, for a given container of the containers and from a kubelet of the given container, health metric values corresponding to health data for the given container.

21. The method of claim 1, wherein determining that the given container is healthy comprises:
determining at least one of a processor utilization or a memory utilization of the container; and
determining that the given container is healthy based on the determination of the at least one of the processor utilization or the memory utilization.
